(19) United States
(12) Patent Application Publication
(10) Pub. No.: US 2026/0308781 A1
(43) Pub. Date: Oct. 8, 2026

(54) ELECTROLYZER

(71) Applicant: INDUSTRIE DE NORA S.P.A., Milano (IT)

(72) Inventors: Elena Carminati, Milano (IT); Andrea Gozzo, Milano (IT); Luciano Iacopetti, Milano (IT)

(21) Appl. No.: 19/483,639

(22) PCT Filed: Jul. 4, 2024
(86) PCT No.: PCT/EP2024/068813

§ 371 Date: Nov. 12, 2025

(30) Foreign Application Priority Data
Jul. 6, 2023 (IT) 102023000014109

(51) Int. Cl. C25B 9/75; C25B 1/04; C25B 9/67; C25B 9/77; C25B 11/036; C25B 15/08

(52) U.S. Cl. CPC C25B 9/75; C25B 1/04; C25B 9/67; C25B 9/77; C25B 11/036; C25B 15/08

(57) ABSTRACT

The present invention refers to an electrolyzer (1) for the production of hydrogen from an alkaline electrolyte. The electrolyzer (1) comprises a first header (11) and a second header (12) between which a plurality of elementary cells (20) and a plurality of bipolar plates (5, 5′, 5″) are stacked. Each bipolar plate (5) separates two adjacent elementary cells. According to the invention, each of said bipolar plates (5, 5′,5″) comprises two plate-form components (5A, 5B) coupled together and configured so as to define one or more inner cavities (66) for the circulation of a cooling fluid. Furthermore, each bipolar plate (5, 5′, 5″) comprises an inlet section (SI) and an outlet section (SV) respectively for the inlet and outlet of said cooling fluid in said one or more inner cavities (66).

### FIELD OF THE INVENTION

The present invention falls within the field of manufacturing of devices for the production of hydrogen by means of water electrolysis. In particular, the invention relates to an electrolyzer for the production of hydrogen and oxygen preferably, but not exclusively, starting from an alkaline electrolyte (for example from a liquid solution of potassium hydroxide).

### PRIOR ART

Over the last few years, the demand for hydrogen has significantly increased in various production areas, such as the production of electricity without polluting emissions. Hydrogen is easily stored and transported, for example through pipelines like those used for gas, and therefore can be made easily available for different applications.

For the production of hydrogen, the use of electrochemical reactors, also called electrolyzers, is known, in which the electrolysis of water is carried out, i.e., the dissociation thereof into hydrogen and oxygen under the effect of an electric current. The existence of different types of electrolysis is equally well known, including alkaline water electrolysis, polymer membrane electrolysis and ceramic membrane electrolysis.

A plant for the production of hydrogen at an industrial level, based on the electrolysis of alkaline water, typically comprises an electrolyzer including a plurality of elementary cells stacked between two headers and locked through the use of clamping means (typically screws) which exert a traction force between the two headers. The dissociation reaction of alkaline water takes place in each of the elementary cells, which very frequently consists of an electrolyte based on potassium hydroxide (also commonly known by the name “potash”).

In each elementary cell there is an anodic portion and a cathodic portion separated by a separator element. The anodic portion and the cathodic portion respectively comprise an anode electrode and a cathode electrode between which the separator element is placed. The anodic portion comprises an anode chamber in which an anode electrode is at least partially housed. Similarly, the cathodic portion comprises a cathode chamber in which a cathode electrode is partially housed. The anode and cathode chambers are defined by a specific frame shared between the two chambers or by a dedicated frame for each chamber. A separator element involved in the electrolysis process according to widely known principles is arranged between the two electrodes (anodic and cathodic).

A bipolar plate made of metallic material is arranged between two adjacent elementary cells, comprising one face/side in electrical contact with the cathode electrode of the cathodic portion of a cell, and with the opposite face/opposite side in electrical contact with the anode electrode of the anodic portion of another adjacent cell.

For each cell, between each frame and the adjacent bipolar plate, as well as between the frames of each chamber (if they are separate), sealing plates are typically provided, normally made of polymeric material.

Typically, the frames of the elementary cells, the sealing plates and the bipolar plates comprise openings arranged and configured so as to define, following the stacking of the cells between the electrolyzer headers, a first potash distribution channel, a second potash distribution channel, a first collection channel for a first reaction product and a second collection channel for a second reaction product, where said reaction products consist of a biphasic solution consisting of reaction gas (hydrogen or oxygen) and unreacted electrolyte/potash.

The first distribution channel and the first collection channel are hydraulically connected, through the respective frames, with the anodic section of each elementary cell, while the second distribution channel and the second collection channel are hydraulically connected, through the respective frames, with the cathodic section of each elementary cell. Through the distribution channel (first or second), the corresponding portion (anodic or cathodic) of each elementary cell is supplied with potash. For each elementary cell, the gas (hydrogen or oxygen) which is generated following the electrolysis reaction and/or any non-dissociated potash exit from the respective portion (cathodic or anodic) of the cell and flow into the corresponding collection channel (first or second).

FIG. 1 is a general diagram of a plant (600) of known type in which an electrolyzer (E) with the structure just described above is placed. In such a plant (600), a first circuit (C1) and a second circuit (C2), that feed the electrolyzer (E), are identified. Each of these circuits comprises a delivery branch (RM1, RM2), hydraulically connected with a corresponding distribution channel, and a return branch (RR1, RR2) hydraulically connected with the corresponding collection channel of the electrolyzer. A circulation pump (P1, P2) is arranged for each circuit (C1, C2), along the delivery branch (RM1, RM2), by means of which the electrolyte/potash is sent to the elementary cells of the electrolyzer (E), while along the return branch (RR1, RR2) a degasser (D1, D2) is arranged, into which the biphasic solution (gas and unreacted liquid solution) flows out of the elementary cells to be after collected in the corresponding collection channel. In each degasser (D1, D2), the corresponding gas (hydrogen or oxygen) separates from the liquid fraction to be stored in appropriate containers (tanks, cylinders or similar) through a first outlet (D1-A, D2-A). Through a second outlet (D1-B, D2-B), the liquid fraction is instead returned to the delivery branch (RM1, RM2) at the suction of the circulation pump (P1, P2). The liquid fraction is mixed (for example at the outlet of the corresponding degasser D1, D2) with other electrolyte/potash coming from an outer tank (T1, T2) so as to reach the operating flow rate which will be pumped towards the electrolyzer by the corresponding circulation pump (P1, P2).

As schematically shown in FIG. 1, for each supply circuit (C1, C2), a heat exchanger (S1, S2) of the liquid/liquid or liquid/air type is arranged along the relative delivery branch. Through such exchangers, the liquid solution is cooled before returning to the electrolyzer so as to limit the subsequent temperature rise which develops following its passage in the elementary cells. Through such exchangers, the liquid solution is therefore cooled before entering the electrolyzer, preventing the subsequent increase in temperature.

Typically, the presence of heat exchangers (S1, S2) is required by the fact that, as is known, the electrolysis reaction is highly exothermic. In fact, the biphasic mixture (gas and non-dissociated/reacted liquid solution) exiting the sections (anodic and cathodic) of the elementary cells of the electrolyzer has a higher temperature than that of the entering liquid solution. The value of the potash operating flow rate is established so as to exceed the nominal one of the electrolysis reaction. Thereby, the heat generated by the exothermic reaction is carried outside the electrolyzer by the fraction of flow rate exceeding the nominal one.

Through the heat exchangers (S1, S2), the operating potash destined to the electrolyzer (E) is therefore cooled to limit the subsequent temperature rise deriving from the hydrolysis reaction, i.e., to maintain the thermal gradient between inlet and outlet within a predetermined range.

However, the Applicant has found that such a temperature gradient determines a highly non-homogeneous distribution of temperatures inside the electrolyzer. This aspect translates into a reduced efficiency of the electrolysis process, as the electrolyte/potash is not capable of reaching and maintaining, inside the entire elementary cell, the ideal thermal level (typically 88+8 C.°) which allows maximum electrical conductivity and therefore maximum efficiency of the electrolysis process.

In addition to this, the heat exchangers, as well as the other components of the gas production plant, are sized based on the expected operating flow rate for the potash which, as indicated above, exceeds the nominal value required by the reaction. This aspect is particularly critical not only in terms of plant construction costs, but also in relation to the overall size, i.e., the final dimensions of the plant itself. It is also observed that the circuits (C₁, C₂) and the related components responsible for allowing the circulation of the potash/electrolyte are typically complex in order to comply with the harsh operating conditions which require the use of highly chemically resistant materials, which are particularly expensive, capable of counteracting high pH and relatively high temperatures.

In addition to this, the size of the heat exchangers, as well as the other components necessary for the treatment of the potash and the biphasic mixture (for example filters and/or degassers), also directly and proportionally impact the times and costs associated with the maintenance operations and therefore in general on the subsequent plant management costs.

To the technical problems listed above, it is added that known as the “battery effect” which is generated when the delivery of electrical current powering the electrolyzer headers is interrupted. Following the interruption of electrical current, a series of reverse current phenomena occur deriving from the formation of parasitic oxidation-reduction pairs which are created during the operation. This phenomenon is mainly powered by the reduction of Ni (IV) to Ni(II) in the compartment which acts as an anode in operation and by the oxidation of Ni(0) to Ni(II) in the compartment which acts as a cathode in operation. The battery effect is particularly negative on the corrosion of metal components inside the electrolyzer, both electrodes and structural ones. Furthermore, the battery effect is all the more intense the higher the temperature of the electrolyzer during the shutdown (lesser ohmic component which opposes the battery effect) and the more the electrolyzer is kept under electrolyte flow, as it allows the electrical communication between the various chambers through the flushing ducts.

### SUMMARY

The main task of the present invention is therefore to provide an electrolyzer which allows overcoming or at least mitigating the limits of the solutions mentioned above. Within the scope of this task, a first object of the present invention is to provide an electrolyzer which allows the electrolyte to operate more effectively, with particular reference to maintaining the temperature of maximum conductivity. Another object of the present invention is to provide an electrolyzer in which, other characteristics being equal, the flow rate of the electrolyte is more limited with respect to that used in the known solutions. Yet another object of the present invention is to provide an electrolyzer which allows to eliminate or in any case mitigate the possible damage deriving from the battery effect mentioned above. A further object of the present invention is to provide an electrolyzer which allows to reduce the construction costs of the plant in which it is to be installed. Yet another object, linked to the previous one, is to provide an electrolyzer which allows to reduce the complexity and size of the other components of the plant in which the electrolyzer itself must be installed. Not least, an object is to provide an electrolyzer which is reliable and easy to build at competitive costs.

The Applicant has found that said task and said object can be achieved by removing the heat generated by the hydrolysis reaction through a cooling fluid different from the electrolyte involved in the reaction and at the place where the same heat is generated. In particular, the Applicant has found that such heat can be removed at the bipolar plates of the electrolyzer and more precisely by configuring them so as to define one or more inner cavities acting as cooling chambers, where such inner cavities comprise an inlet and outlet section for said cooling fluid. Further, for each portion of the elementary cell, a spacer made of metallic material is provided between the corresponding electrode (anodic or cathodic) and a corresponding bipolar plate. Overall, the Applicant has found that the use of a bipolar plates internally cooled and in thermal contact with the spacers allow an effective dissipation of the heat generated by the electrolysis reaction.

Specifically, the Applicant has found that the task and objects described above can be achieved through an electrolyzer according to Claim 1. In particular, the electrolyzer according to the invention allows the production of hydrogen from an alkaline electrolyte and comprises:
a first header and a second header made of metallic material;
a plurality of elementary cells and a plurality of bipolar plates arranged between said headers, in which two adjacent cells are separated by one of said bipolar plates;
clamping elements which mechanically connect the headers so that said elementary cells and said bipolar plates remain stably stacked between the headers themselves.

According to the invention, each elementary cell comprises:
an anodic portion which includes an anode electrode and an anodic frame defining a chamber in which said anode electrode is housed, at least in part, where said anodic portion includes at least one sealing plate interposed between the anodic frame and one of said bipolar plates, wherein said anodic portion further comprises an anode space made of metallic material and interposed between said one of said bipolar plates and the anode electrode;
a cathodic portion which includes a cathode electrode and a cathodic frame defining a chamber in which said cathode electrode is housed, at least in part, where the cathodic portion includes at least one sealing plate interposed between the cathodic frame and another one of said bipolar plates, wherein said cathodic portion further comprises a cathode spacer made of metallic material and interposed between said another one of said bipolar plates and the cathode electrode,
a separator element which separates the anodic portion from the cathodic portion;
at least a further sealing plate interposed between the anodic frame of the anodic portion and the cathodic frame of the cathodic portion.

The electrolyzer according to the invention further comprises:
a first distribution channel of said alkaline electrolyte and a first collection channel of a first reaction product comprising mainly oxygen, in which for each of said elementary cells, said channels are hydraulically connected to the chamber of the anodic portion by means of grooves defined by said anodic frame;
a second distribution channel of said alkaline electrolyte and a second collection channel of a second reaction product comprising mainly hydrogen, in which for each of the elementary cells, said second distribution channel and said second collection channel are hydraulically connected to the chamber of the cathodic portion by means of grooves defined by the cathodic frame.

According to the invention, each of the bipolar plates comprises two plate-form components coupled together and configured so as to define at least one inner cavity for the circulation of a cooling fluid, in which each bipolar plate comprises an inlet section and an outlet section respectively for the inlet and outlet of said fluid into said one or more inner cavities. The electrolyzer according to the invention further comprises:
a cooling fluid delivery channel hydraulically connected with the inlet section of each of said bipolar plates; and
a cooling fluid return channel hydraulically connected with the outlet section of each of the bipolar plates.

Advantageously, the electrolyzer is cooled from the inside, i.e., where the heat is generated following the hydrolysis reaction. The cooling occurs through a fluid different from the electrolyte and this aspect allows the operating flow rate of the electrolyte itself to be limited on one hand and the size and bulk of the components of the plants responsible for circulating the electrolyte on the other. The spacers made of metallic material are in thermal contact with the bipolar plates. This arrangement advantageously increases the heat transfer from the portions (anodic and cathodic) to the cooling fluid circulating in the inner cavities of the bipolar plates.

By separating the cooling of the electrolyte from its circulation through the electrolyzer cells, the circulation of the cooling fluid can be kept active even during electrolyzer shutdowns, i.e., when the circulation of the electrolyte is interrupted. Thereby the quantity of heat to be removed from the electrolyzer is limited to only the fluid residing inside the anodic and cathodic chambers. The cooling achieved through the bipolar plates and the interruption of the flow on the circulating electrolyte rapidly raises the inner resistance of the electrolyzer and therefore significantly reduces the battery effect and its negative effects on the integrity of the electrolyzer itself.

According to a possible embodiment, the cooling fluid is water. However, various cooling fluids can be used which can operate both in the field of sensible heat (without change of state from liquid to vapor) and latent heat (heat removed through the change of state from liquid to vapor). These cooling fluids are preferably, but not exclusively, water-based, either pure water or water added with glycol, polyelectrolytes or colloids, or organic with a change of state temperature close to the operating temperature of the electrolyzer.

According to a possible embodiment, the delivery channel comprises an inlet and the return channel comprises an outlet. Said inlet and said outlet are both positioned at one of said headers. According to a possible embodiment, the first distribution channel and the second distribution channel of the electrolyte respectively comprise a first inlet and a second inlet positioned on one of said headers opposite to that on which said inlet and said outlet are positioned, respectively, of the delivery channel and the return channel of the cooling fluid, in which said first collection channel and said second collection channel of the reaction products respectively comprise a first outlet and a second outlet also positioned on said one of said headers.

According to a possible embodiment, for each of the elementary cells, each frame comprises:
a first distribution opening and a first collection opening hydraulically connected to the relative chamber defined by the relative frame; in which the first distribution opening and the first collection opening are defined in diagonally opposite positions;
a second distribution opening and a second collection opening not hydraulically connected to the relative chamber defined by the relative frame, in which the second distribution opening and the second collection opening are defined in diagonally opposite positions;
a delivery opening and a return opening intended to be passed through by the cooling fluid during the use of the electrolyzer.

According to a possible embodiment, the sealing plates comprise six openings, each configured and positioned in a compliant manner to a corresponding opening of each of said frames. Furthermore, each bipolar plate comprises six openings each of which is configured and positioned in a compliant manner with one of said six openings of each of said frames and one of said six openings of each of said sealing plates.

According to a preferred embodiment, following the stacking of the elementary cells between said headers:
one of the distribution openings of each frame, a corresponding first opening of each sealing plate and a corresponding first opening of each bipolar plate as a whole define the first electrolyte distribution channel;
the other of said distribution openings of each frame, a corresponding second opening of each sealing plate and a corresponding second opening of each bipolar plate as a whole define the second electrolyte distribution channel;
one of said collection openings of each frame, a corresponding third opening of each sealing plate and a corresponding third opening of each bipolar plate as a whole define the first electrolyte collection channel;
the other of said collection openings of each frame, a corresponding fourth opening of each sealing plate and a corresponding fourth opening of each bipolar plate as a whole define the second electrolyte collection channel;
said delivery opening of each frame, a corresponding fifth opening of each sealing plate and a corresponding fifth opening of each bipolar plate as a whole define the first delivery channel of the cooling fluid intended to pass through the bipolar plates internally; and finally
said return opening of each frame, a corresponding sixth opening of each sealing plate and a corresponding sixth opening of each bipolar plate as a whole define said return channel of the cooling fluid exiting the bipolar plates.

According to a possible embodiment, each component of the bipolar plate comprises a flat part and a molded part surrounded by the flat part, in which, for each of said components, said molded part is recessed with respect to a reference plane on which the flat part lies, and in which said components are connected at the corresponding flat parts so as to be symmetrical with respect to a contact plane coinciding with the reference plane, and in which said molded part of the first component faces the molded part of the second component, said one or more inner cavities of said bipolar plate being defined between said mutually facing molded parts of said components.

Preferably, for each of the components the molded part comprises at least one area with a substantially wavy shape defined by grooves alternating with ridges, and in which following the connection of said components, each of the ridges of the molded part of the first component contacts a corresponding ridge of the molded part of the second component, and in which, following said connection, the inner cavities for the circulation of the cooling fluid are defined between two mutually facing grooves of the molded parts of said components.

According to an alternative embodiment, for each of the components of the bipolar plate, the molded part comprises a recessed portion with respect to the reference plane on which the flat part lies and a plurality of protrusions which develop from the recessed portion beyond such a reference plane, and in which, following the connection of said components, the recessed portion of the molded part of the first component remains arranged on a side opposite that in which the recessed portion of the molded part of the second component is placed, in which an inner cavity useful for the flow of the cooling fluid is defined between the recessed portions; the protrusions of the first component contact the inner surface of the recessed portion of the second component, while the protrusions of the second component contact the inner surface of the recessed portion of the first component.

According to a preferred embodiment, the components of the bipolar plate consist of two flat metal plates each comprising an inner surface and an outer surface opposite the inner surface; each of the metal plates comprises a plurality of grooves which develop in the thickness of the plate itself starting from the corresponding inner surface; said components are coupled so that the inner surface of one component is in contact with the inner surface of the other component and so that, following such contact, the grooves of one component face corresponding grooves of the other component, where a pair of mutually facing grooves defines one of the inner cavities for the flow of the cooling fluid. Further, according to this embodiment, for each of the metal plates, the corresponding outer surface is flat.

### LIST OF FIGURES

Further features and advantages of the invention will be better evident from the examination of the following detailed description of a preferred, but not exclusive, embodiment of an electrolyzer according to the invention, illustrated by way of indicative and non-limiting purposes, with the support of the attached drawings, in which:

FIG. 1 is a schematic view of a hydrogen production plant known in the state of the art;

FIG. 2 is a view of a group of components of a hydrogen production plant comprising an electrolyzer according to the present invention;

FIG. 3 is a perspective view of the electrolyzer of FIG. 2;

FIG. 4 is a side view of the electrolyzer of FIG. 3;

FIG. 5 is a frontal view according to the section plane V-V of FIG. 4;

FIG. 6 is a perspective view according to plane VI-VI of FIG. 4;

FIG. 7 is a perspective view according to the section plane V-V of FIG. 4;

FIG. 8 is an exploded view of the electrolyzer of FIG. 2;

FIG. 9 is an exploded view of an elementary cell of the electrolyzer of FIG. 2;

FIG. 10 is a view of a first embodiment of a bipolar plate of an electrolyzer according to the invention;

FIGS. 11 and 12 are frontal and perspective views, respectively, each of a component of the bipolar plate of FIG. 10;

FIG. 13 is a view according to the section plane XIII-XIII of FIG. 10;

FIG. 14 is a view of a second embodiment of a bipolar plate of an electrolyzer according to the invention;

FIG. 15 is a front view of a component of the bipolar plate of FIG. 14;

FIG. 16 is a view according to the section plane XVI-XVI of FIG. 14;

FIG. 17 is a view of a third embodiment of a bipolar plate of an electrolyzer according to the invention;

FIGS. 18 and 19 are frontal and perspective views, respectively, each of a component of the bipolar plate of FIG. 10;

FIG. 20 is a view according to the section plane XX-XX of FIG. 17;

FIG. 21 is a diagram of a hydrogen production plant comprising an electrolyzer according to the invention.

The same reference numbers and letters in the figures identify the same elements or components.

### DETAILED DESCRIPTION

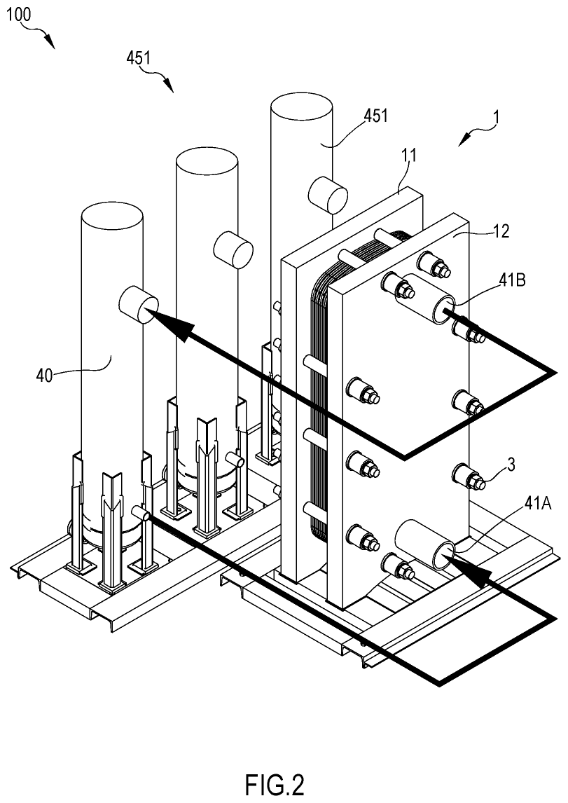

With reference to the aforementioned figures, the present invention therefore relates to a device for the electrolysis of water, in particular alkaline water. FIG. 2 is a perspective view of a hydrogen production plant 100 comprising an electrolyzer 1 according to the invention. Preferably, through the electrolyzer 1, hydrogen and oxygen are obtained from an alkaline electrolyte represented by a liquid solution containing potassium hydroxide (hereinafter referred to as potash). However, the electrolyzer 1 could be used to obtain oxygen and hydrogen from a different liquid solution, for example from a solution based on sodium hydroxide or concentrated and alkalised neutral salts such as potassium chlorate.

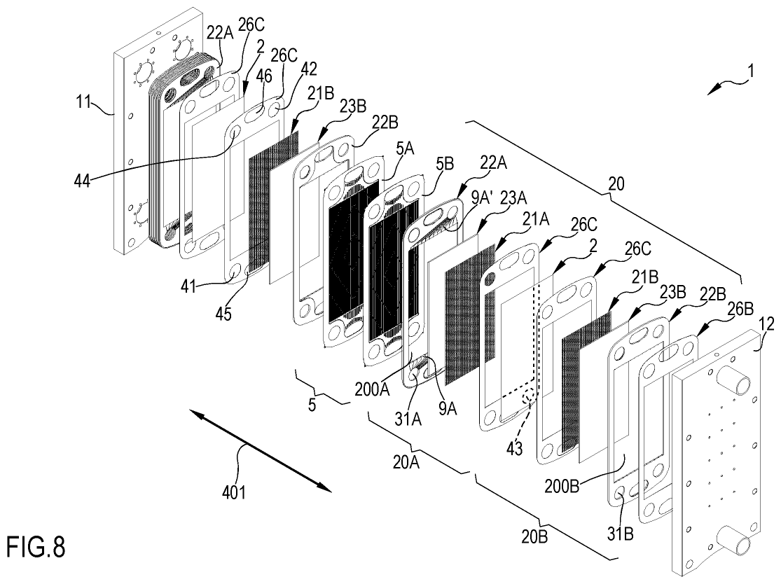

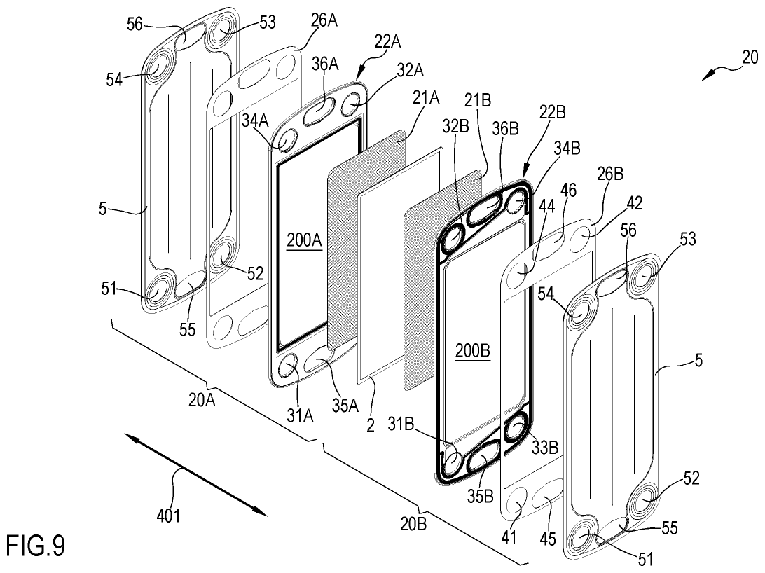

The electrolyzer 1 according to the invention comprises a plurality of electrolysis cells 20 (hereinafter also indicated with the expression “elementary cells”) stacked, along a longitudinal direction 401 (indicated in FIGS. 8 and 9), between a first header 11 (or anodic header) and a second header 12 (or cathodic header) opposite each other and made of metallic material. Each elementary cell 20 is separated from the adjacent one through a pair of bipolar plates (indicated in FIGS. 8 and 9 with the reference 5). The electrolyzer 1 is provided with clamping elements 3 (preferably in the form of stud screws) which mechanically connect the two headers 11, 12 by exerting a traction force such that the elementary cells 20 and the bipolar plates 5 indicated above define, overall, a compact structure, essentially a “sandwich”.

For descriptive purposes only, in the remainder of the description the expression “first cell” means the elementary cell immediately adjacent to the anodic header 11, while the expression “last cell” means the cell immediately adjacent to the cathodic header 12.

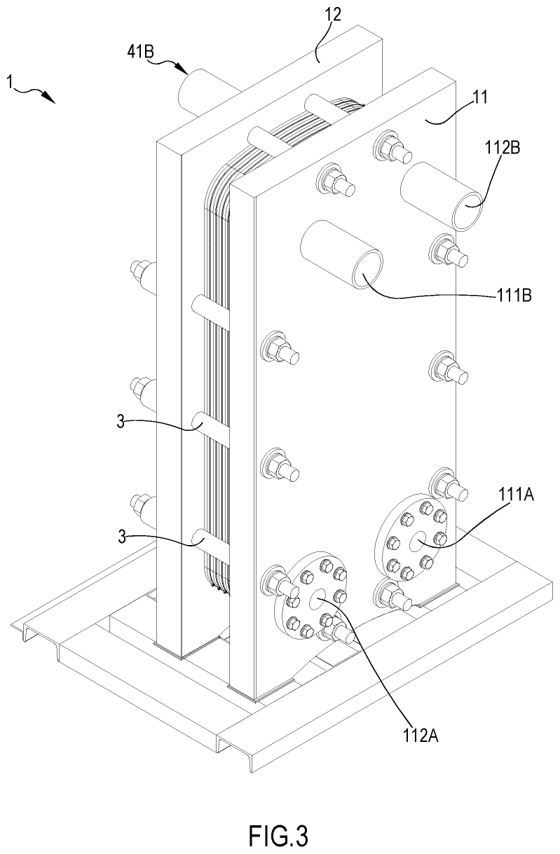

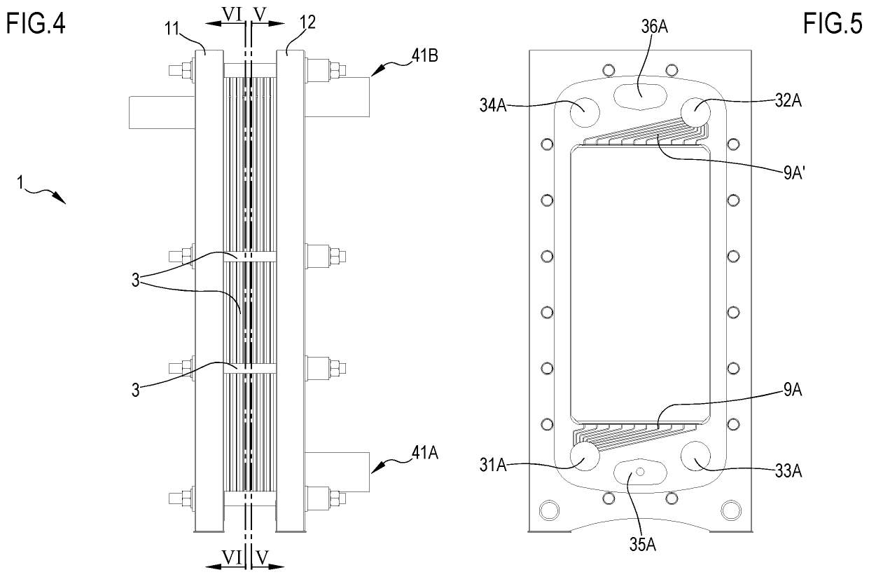

FIGS. 3 and 4 are a perspective view and a side view, respectively, of the electrolyzer 1, while FIG. 8 is an exploded view of the same electrolyzer which allows the sequential arrangement (stacking) of the elementary cells 20 to be observed. FIG. 9 instead allows observing the structure of an elementary cell 20 of the same electrolyzer 1 in detail.

With reference to such figures, each elementary cell 20 comprises an anodic portion 20A which includes an anode electrode 21A and an anodic frame 22A. This delimits a chamber 200A in which the anode electrode 21A is housed, at least in part. Said chamber 200A is axially delimited (i.e. delimited along said longitudinal direction 401) by one of the bipolar plates 5. Therefore, the anodic frame 22A delimits the chamber 200A laterally, that is according to two directions each perpendicular to the longitudinal directions 401.

Each elementary cell 20 also comprises a cathodic portion 20B which includes a cathode electrode 21B and a cathodic frame 22B which delimits a chamber 200B in which the cathode electrode 21B is housed, at least in part. The chamber 200B of the cathodic portion 20B is axially delimited by another bipolar plate 5 different from the one delimiting the chamber 200A of the anodic portion 20A. The cathodic frame 22B delimits laterally the cathodic portion 20B. For each elementary cell 20, the two portions 20A, 20B defined above are separated by a separator element 2 (for example a membrane). Preferably, but not exclusively, the two frames 22A, 22B envisaged for the elementary cell 20 are made of polymeric material, but they could also be made partially of metallic material as long as they are electrically insulated towards the outside.

For the purposes of the invention, for the two frames 22A, 22B the terms “anodic” and “cathodic” are used to indicate one of the cell portions (anodic and cathodic) to which the relative frame belongs, without any reference to the electric charge of the frame itself.

In any case, for each portion 20A, 20B of the elementary cell 20, the corresponding electrode 21A or 21B is in electrical contact with the immediately adjacent bipolar plate 5 that delimits along the longitudinal direction 401 the relative elementary cell. In this regard, in the case of the first cell, the electrode 21A of the anodic portion 20A is in electrical contact with the anodic header 11, while the electrode 21B of the cathodic portion 20B is in electrical contact with a bipolar plate 5. Similarly, for the last cell, the electrode of the anodic portion 20A is in electrical contact with a bipolar plate 5, while the electrode 21B of the cathodic portion 20B is in electrical contact with the second header 12.

As shown in FIG. 9, each portion 20A, 20B of the anodic portion comprises a sealing plate 26A, 26B interposed between the corresponding frame 22A, 22B and the relative bipolar plate 5 (or header 11,12 in the case of the first and last cell). Each elementary cell 20 also comprises at least a further sealing plate 26C (as shown in FIG. 8) interposed between the two frames 22A, 22B of the cell itself. On this regard, in the solution of FIG. 8, at least two sealing plates 26C are provided.

Preferably, the sealing plates 26A, 26B, 26C are made of a polymeric material resistant to other temperatures and each one has the purpose of ensuring the hydraulic seal between the two components between which it is interposed.

With reference to FIG. 8, according to the invention, for each elementary cell 20, the anodic portion 20A comprises an anodic spacer 23A at least partially housed in the housing chamber defined by the anodic frame 22A. The anodic spacer 23A is interposed between the bipolar plate 5 (or anodic header 11 in the case of the first cell) and the anode electrode 21A so as to ensure the electrical continuity between these parts. For a similar purpose, the cathodic portion 20B comprises a cathodic spacer 23B made of metallic material interposed between the cathode electrode 21B and the bipolar plate 5 (or cathodic header 12 in the case of the last cell). Preferably, the spacers 23A, 23B are made of metallic material (for example in the form of mesh) and configured so as to allow the diffusion of the electrolyte in the chamber 200A, 200B (anodic or cathodic) defined by the respective frame (anodic and cathodic) and in which they are positioned. Each of the spacers 23A, 23B is therefore in thermal contact with a corresponding bipolar plate 5 so that the heat generated by the electrolysis reaction can be transferred to the bipolar plates by thermal conduction. Advantageously, the spacers 23A, 23B also allow to balance the internal pressure between the portions of the cell (anodic and cathodic) so that the stresses on the separator element 2 are advantageously reduced and its durability increased.

With particular reference to the sectional views in FIGS. 5, 6 and 7, the electrolyzer 1 according to the invention comprises a first potash distribution channel 11A which, for each elementary cell 20, is hydraulically connected to the chamber 200A defined by the anodic frame 22A in which the corresponding anode electrode 21A is housed, at least in part; the electrolyzer 1 further comprises a second potash distribution channel 12A which, for each elementary cell 20, is hydraulically connected with the chamber 200B defined by the relative cathodic frame 22B in which the corresponding cathode electrode 21B is housed, at least in part. In particular, the first potash distribution channel 11A and the second potash distribution channel 12A are hydraulically connected with a relative chamber 200A, 200B by means of a grooves 9A, 9B defined by the relative frame 22A, 22B (cathodic or anodic).

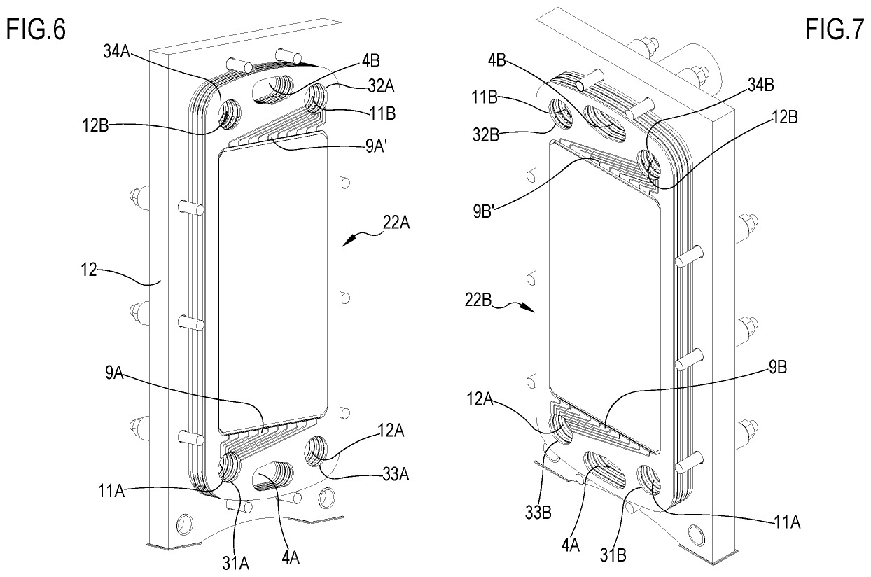

FIG. 6 shows the anodic frame 22A, while FIG. 7 shows the cathodic frame 22B of the same elementary cell. The components of such a cell (separator, electrodes, and sealing plates) provided between the frames 22A, 22B are not shown in these figures.

The electrolyzer 1 also comprises a first collection channel 11B of a first reaction product comprising mainly oxygen. For each elementary cell 20, said first collection channel 11B is hydraulically connected to said chamber 200A defined by said anodic frame 22A. The electrolyzer 1 also comprises a second collection channel 12B of a second reaction product mainly comprising hydrogen. For each elementary cell 20, said second collection channel 12B is hydraulically connected to the cathodic portion 20B of each elementary cell 20. In particular, first collection channel 11B and the second collection channel 12B are hydraulically connected with a relative chamber 200A, 200B by means of grooves 9A′, 9B′ defined by the relative frame 22A, 22B (cathodic or anodic).

In practice, the first collection channel 11B has the purpose of conveying the oxygen generated by the electrolysis reaction and possibly a part of unreacted, i.e., not dissociated, potash. Similarly, the second collection channel 12B conveys the hydrogen generated by the electrolysis reaction and possibly a part of unreacted potash. Therefore, the two collection channels 11B, 12B collect a monophasic or biphasic solution depending on the presence or absence of unreacted potash.

The distribution channels 11A, 12A and the collection channels 11B, 12B are defined following the stacking of the elementary cells 20. For this purpose, as better specified below, the frames 21A, 21B, the bipolar plates 5 and the sealing plates 26A, 26B, 26C comprise openings which, due to the stacking effect, align with each other, defining each of said channels 11A, 12A, 11B, 12B as better specified below. On this regard, with refer to the frames 22A, 22B the term “grooves” 9A, 9A′, 9B, 9B′ wants to indicate generally a plurality of hydraulic passages defined on the structure of a relative frame 22A, 22B so as to connect hydraulically a corresponding distribution channel 11A, 12A or a collection channel 11B, 12B with a corresponding portion 20A, 20B of an elementary cell.

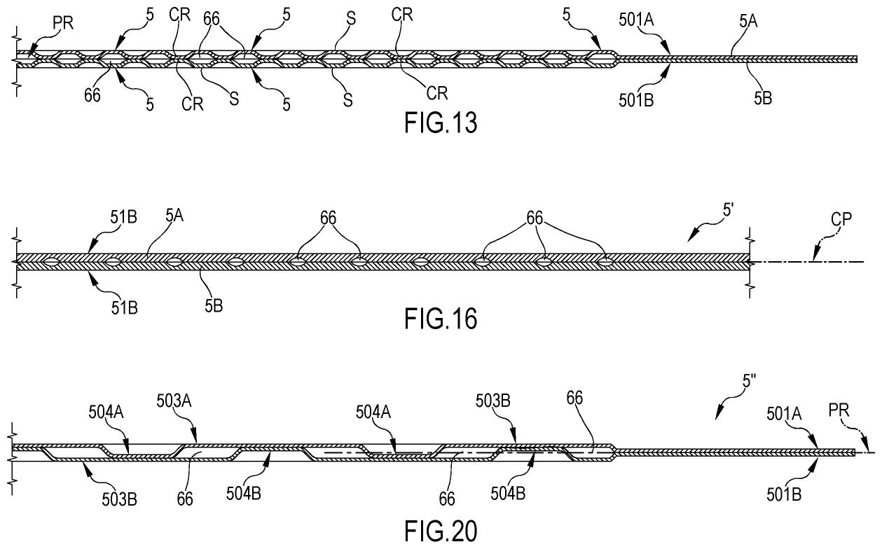

According to the invention, each of the bipolar plates 5 is defined by two components 5A and 5B coupled together and configured so as to define one or more inner cavities (i.e., passages) for the circulation of a cooling fluid, preferably a coolant (e.g., water). Each bipolar plate 5 comprises an inlet section SI and an outlet section SV respectively for the inlet and outlet of the cooling fluid into/from inner cavities (indicated in FIGS. 13, 14, 16 and 20 with the reference 66).

According to the invention, the electrolyzer 1 comprises a delivery channel 4A of the cooling fluid hydraulically connected to the inlet section SI of each bipolar plate 5 and a return channel 4B of the same fluid hydraulically connected to the outlet section SV of each bipolar plate 5. In practice, the fluid coming from a source outside the electrolyzer 1 (for example a tank 400) flows through the delivery channel 4A and is distributed, through the relative inlet sections SI, in the inner cavities 66 of each of the bipolar plates 5. Through the relative outlet section SV, the cooling fluid exiting from the inner cavities of each bipolar plate 5 collects in the return channel 4B which takes it back to the outside of the electrolyzer 1.

Advantageously, the passage of the cooling fluid in the bipolar plates 5 counteracts the increase in heat to which they, and in general all the components of the elementary cells 20, would be subjected due to the electrolysis reaction. Therefore, the heat is advantageously removed where it is generated, i.e., from inside the electrolyzer 1 where the electrolysis reaction occurs. On this regard, as above indicated, the spacers 23A, 23B made of metallic material and provided in the portions of the elementary cells promote the transmission heat to the bipolar plates 5.

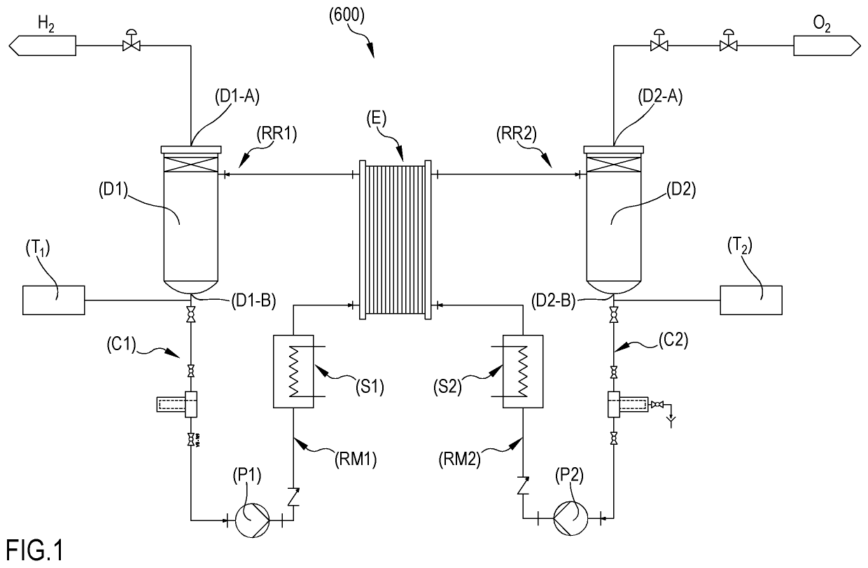

The heat is removed using a cooling fluid (preferably a liquid) which is different from the electrolyte involved in the electrolysis reaction. It follows that the operating flow rate of the electrolyte can be advantageously close to the nominal flow rate of the electrolysis reaction. This aspect translates into a reduction in the size of the plant components, outside the electrolyzer, necessary for the circulation of the electrolyte and reaction products. In this regard, the inner cooling of the electrolyzer allows the elimination of the outer exchangers (S1, S2 in FIG. 1) currently used to cool the electrolyte before its entry into the electrolyzer.

In the following the cooling fluid is also indicated with the expression cooling water (or cooling water/fluid), but this does not mean that a different liquid or a different fluid could be used as the cooling fluid. Furthermore, in the following the electrolyte will also be indicated with the term potash, without any limitation to the use of another type of electrolyte.

In accordance with a possible embodiment visible in the figures, the delivery channel 4A comprises an inlet 41A at one of the two headers 11, 12, while the return channel 4B comprises an outlet 41B at the same header 11, 12 (see in particular FIG. 2). Preferably, the inlet and outlet are therefore positioned on the same header (cathodic 12 in the figures), and more precisely on the header opposite to that (anodic 11 in the figures) on which the inlets 111A, 111B of the potash distribution channels 11A, 12A are defined. In an alternative embodiment, the inlet 41A and outlet 41B defined above could be defined on different headers.

With reference to FIGS. 3, 6 and 7, in accordance with a preferred embodiment shown in the figures, the first distribution channel 11A and the second distribution channel 12A of the potash respectively comprise a first inlet 111A and a second inlet 112A positioned on a header (the anodic one in the figures) of the electrolyzer 1 opposite to that (cathodic in the figures) where the inlet 41A of the delivery channel 4A and the outlet 41B of the return channel 4B of the cooling fluid are positioned. Furthermore, the first return channel 11B and the second return channel 12B of the reaction products respectively comprise a first outlet 111B and a second outlet 112B positioned on the same header on which said first inlet 111A and said second inlet 112A of said distribution channels 11A, 12A are positioned.

In other words, according to a preferred solution, the management of the electrolyte/potash, in terms of entry and exit from the electrolyzer, is envisaged at a header opposite that provided for the conduct (entry/exit) of the cooling fluid. In particular, as visible from FIG. 2, the conduct of the electrolyte is preferably envisaged on the header closest to the degassers 451, 452 into which the first reaction product conveyed by the first collection channel 11B and the second reaction product conveyed by the second collection channel 12B flows.

With particular reference to FIG. 2, the delivery channel 4A (and consequently its inlet 41A) is defined in a position vertically below the return channel 4B (and consequently its outlet 41B) as clearly indicated by the arrows indicating the inlet and outlet direction of the cooling fluid. Preferably, the potash distribution channels 11A, 12A are also arranged in a vertical position below said reaction product collection channels 11B, 12B. As can be seen in particular from FIGS. 6 and 7, the first return channel 11B is defined in a position vertically above the second distribution channel 12A and the second return channel 12B is defined in a position vertically above the first distribution channel 11A.

With particular reference to FIGS. 5, 6, 7, 8 and 9, for each elementary cell 20, both frames 22A, 22B comprise a first distribution opening 31A, 33B and a first collection opening 32A, 34B hydraulically connected to a relative chamber 200A, 200B. Such connection is made possible by grooves 9A, 9B, 9A′, 9B′ (indicated in FIGS. 5 and 8) preferably defined on the side opposite to the one facing the adjacent bipolar plate 5. In particular, the grooves indicated with the reference 9A, 9B connect the distribution opening 31A, 33B with the relative chamber 200A, 200B. The latter is hydraulically connected with the collection opening 32A, 34B by the grooves indicated with the reference 9A′, 9B′.

Each frame 22A, 22B further comprises a second distribution opening 33A, 31B and a second collection opening 34A, 32B which however are not hydraulically connected to said chamber 200A, 200B. Preferably, the first distribution opening 31A, 33B and the relative first collection opening 32A, 34B are arranged in diagonally opposite positions.

For each frame 22A, 22B the relative first distribution opening 31A, 33B and the first collection opening 32A, 34B are “active” openings as they are intended to allow, during the use of the electrolyzer, the circulation of the potash inside the chamber 200A, 200B defined by the frame itself. Instead, the second distribution opening 33A, 31B and the second collection opening 34A, 32B are “passive”, as they are not involved in the circulation of the potash in the same housing chamber 200A, 200B.

With particular reference to FIG. 9, it can be observed for each elementary cell 20 that the anodic frame 22A and the cathodic frame 22B are oriented so that each “active” opening of the anodic frame 22A is aligned and compliant with a “passive” opening of the cathodic frame 22B and vice versa. Therefore, the first distribution opening 31A (active) and the second distribution opening 33A (passive) of the anodic frame 22A will be aligned and compliant respectively with the second distribution opening 31B (passive) and the first distribution opening 33B (active) of the 22B cathodic frame.

For each elementary cell 20, each frame 22A, 22B comprises a delivery opening 35A, 35B and a return opening 36A, 36B intended to be passed through by the cooling fluid during use of the electrolyzer 1. As visible in the figures, preferably said delivery opening 35A, 35B and said return opening 36A, 36B are each defined between one of said “active” openings and one of said “passive” openings.

With reference to FIGS. 8 and 9, for each elementary cell 20, the sealing plates 26A, 26B, 26C comprise six openings 41, 42, 43, 44, 45, 46 each shaped and positioned in a compliant manner to a corresponding opening 31A, 32A, 33A, 34A, 35A, 36A-31B, 32B, 33B, 34B, 35B, 36B of each of the two frames 22A, 22B. Similarly, each bipolar plate 5 comprises six openings 51, 52, 53, 54, 55, 56, each of which is shaped and positioned correspondingly to one of the six openings 31A, 32A, 33A, 34A, 35A, 36A-31B, 32B, 33B, 34B, 35B, 36B of each frame 22A, 22B and to one of the six openings 41, 42, 43, 44, 45, 46 provided for each sealing plate 26A, 26B, 26C.

Overall, following the stacking of the elementary cells 20 between the two headers 11, 12, i.e., following the assembly of the electrolyzer 1:
one of the two distribution openings 31A or 31B of each frame 22A, 22B, a corresponding first opening 41 of each sealing plate 26A, 26B, 26C and a corresponding first opening 51 of each bipolar plate 5 collectively define the first potash distribution channel 11A;
the other of the two distribution openings 33A or 33B of each frame 22A, 22B, a corresponding second opening 43 of each sealing plate 26A, 26B, 26C and a corresponding second opening 52 of each bipolar plate 5 collectively define the second potash distribution channel 12B;
one of said collection openings 32A or 34B of each frame 22A, 22B, a corresponding third opening 42 of each sealing plate 26A, 26B, 26C and a corresponding third opening 53 of each bipolar plate 5 collectively define the first potash collection channel 11B;
the other of said collection openings 34A, 34B of each frame 22A, 22B, a corresponding fourth opening 44 of each sealing plate 26A, 26B, 26C and a corresponding fourth opening 54 of each bipolar plate 5 collectively define the second potash collection channel 12B;
the delivery opening 35A, 35B of each frame 22A, 22B, a corresponding fifth opening 45 of each sealing plate 26A, 26B, 26C and a corresponding fifth opening 55 of each bipolar plate 5 collectively define the first delivery channel 4A of the cooling fluid destined to pass inside the bipolar plates 5; and finally
the return opening 36A, 36B of each frame 22A, 22B, a corresponding sixth opening 46 of each sealing plate 26A, 26B, 26C and a corresponding sixth opening 56 of each bipolar plate 5 collectively define the return channel 4B of the cooling fluid destined for exiting the bipolar plates 5.

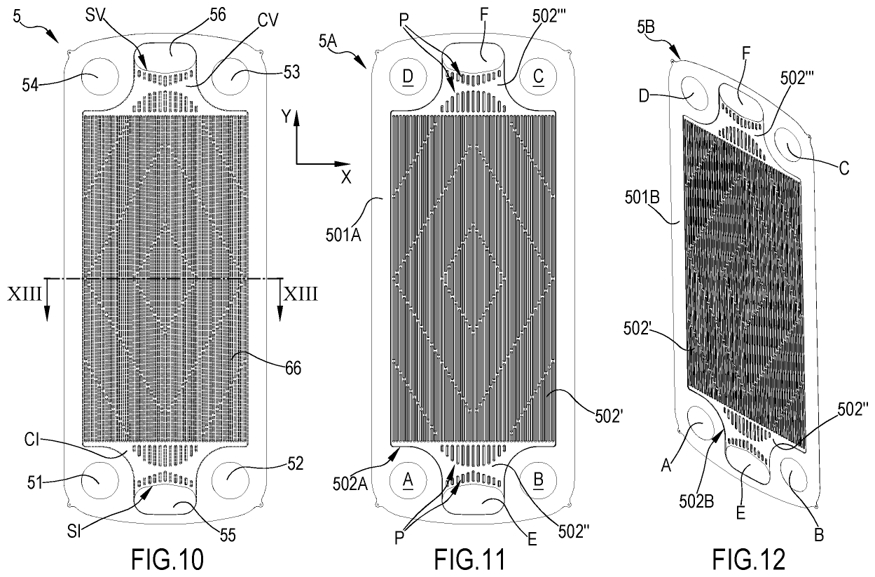

FIGS. 10 to 13 show the shape of the bipolar plate 5 of the electrolyzer 1 shown in FIG. 9 (exploded view) in detail. In particular, FIG. 10 shows the bipolar plate 5 from the front which mainly develops along a longitudinal direction Y orthogonal to a transversal direction X. Considering the bipolar plate 5 in a condition of use (as in FIGS. 2 and 3), i.e., arranged inside the electrolyzer 1, the longitudinal direction Y comes to substantially coincide with the vertical direction. In the following, the expressions “longitudinal plane” and “transversal plane” refer to a plane parallel to the longitudinal direction Y and the transversal direction X, respectively. According to the invention, the bipolar plate 5 is defined by the union of two components 5A, 5B which in the case shown in FIGS. 10 to 13 are obtained through a molding operation of a metal sheet, preferably, but not exclusively, in steel.

FIGS. 11 and 12 are a front view of a first component 5A and a perspective view of a second component 5B, respectively. For each of them, a flat part 501A, 501B and a molded part 502A, 502B are identified, peripherally surrounded by the relative flat part 501A, 501B. Each of the openings 51, 52, 53, 54, 55, 56 envisaged in the bipolar plate 5 is defined following the union of corresponding openings (indicated with the letters A, B, C, D, E, F defined in each of the two components 5A, 5B).

More precisely, for each component 5A, 5B, the corresponding flat region 501A, 501B defines four openings (A, B, C, D) which form, following the connection of the two components 5A, 5B, the four openings 51, 52, 53, 54 of the bipolar plate 5. The latter, following the stacking of the elementary cells 20, contribute to define the potash distribution channels 11A, 12A and the reaction product collection channels 11B, 12B.

For each component 5A, 5B, the corresponding molded region 502A, 502B instead defines two further openings (E, F) which, following the connection of the two components 5A, 5B, form the fifth opening 55 and the sixth opening 56 of the bipolar plate 5. The latter, following the stacking of the elementary cells 20, contribute to define the delivery channel 4A and the return channel 4B for the cooling fluid.

For each component 5A, 5B, the molded region 502A, 502B is recessed with respect to a reference plane PR in which the relative flat region 501A, 501B develops. More precisely, the molded region 502A, 502B comprises a central area 502′, substantially rectangular in shape, having a substantially wavy shape, i.e., defined by grooves S alternating with ridges CR. Therefore, the transversal section of such a central area has a profile comprising minimum points which lie on a plane which is spaced apart with respect to said reference plane PR and maximum points which lie on a plane which instead coincides with said reference plane PR (see sectional view in FIG. 13).

For each component 5A, 5B the molded region 502A, 502B further comprises two bottleneck areas 502″, 502′″ opposite each other with respect to said central rectangular area 502′. Again, with reference to FIGS. 11 and 12, it is observed that such bottleneck areas 502″, 502′″ have wavy portions (indicated with the reference P) which develop symmetrically with respect to the longitudinal axis Y of the relative component 5A, 5B. Overall, the two bottleneck areas 502″, 502′″ are preferably symmetrical with respect to the transversal direction X.

With reference to FIGS. 11 and 12, the two components 5A, 5B are connected, through welding, at the respective flat regions 501A, 501B so as to be specular with respect to a contact plane (coinciding with the reference plane PR indicated above). Following such a connection, the molded region 502A of the first component 5A is facing/opposite the molded region 502B of the second component 5B. The ridges of the wavy portions of the central area 502′ and the bottleneck areas 502″, 502′″ of the molded region 502A of the first component 5A contact corresponding ridges of the wavy portions of the molded region 502B of the second component (see section in FIG. 13). Therefore, following said connection between the components 5A, 5B, inner cavities 66 are generated, each delimited between two facing grooves S of the two components 5A, 5B. With reference in particular to FIG. 10, such inner cavities 66 develop longitudinally, resulting in being parallel and transversally side by side with each other.

With reference again to FIG. 10, in the bipolar plate 5 there is a first chamber CI defined by two bottleneck areas 502″ (each of a respective component 5A, 5B) facing and opposite with respect to the contact plane PR. A second chamber CV is also identified, which is defined by two other bottleneck areas 502′″ (each of a respective component 5A, 5B) facing and opposite with respect to the same contact plane PR.

The first chamber CI allows the entry of the cooling fluid into the inner cavities 66 and therefore defines the inlet section SI through which the fluid enters between the two components 5A, 5B of the bipolar plate 5. The second chamber CV conveys the cooling fluid coming from the inner sliding cavities 66 and therefore defines the outlet section SV of the cooling fluid. In practice, during the normal operation of the electrolyzer 1, the cooling fluid enters and is distributed in the inlet chamber CI of the bipolar plate 5 to then pass through the inner cavities 66 defined by the connection of the two central areas 502′ of the two components 5A, 5B of the bipolar plate 5. After having passed through the inner cavities 66, the fluid is conveyed into the outlet chamber CV up to the outlet section SV. Therefore, together with the inner cavities 66, the first chamber CI and the second chamber CV contribute to the circulation of the cooling fluid and therefore to the removal of heat.

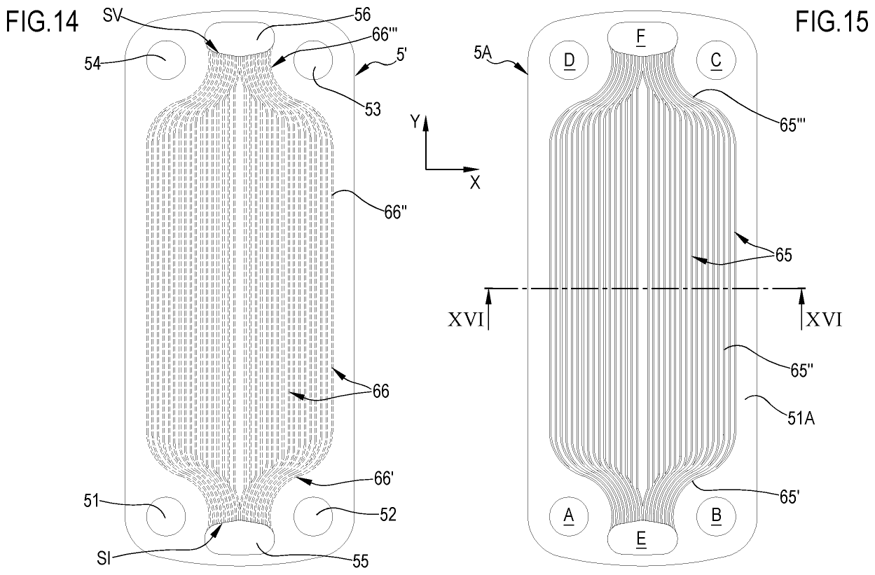

FIGS. 14, 15 and 16 refer to a possible embodiment, alternative to that just described above, of a bipolar plate of an electrolyzer according to the invention. To differentiate it from the previous embodiment, the plate is indicated with the reference 5′, while the two components thereof are indicated with the references 5A and 5B already used previously.

Specifically, in this embodiment, the two components 5A, 5B consist of two flat metal plates which develop mainly along the longitudinal direction Y. The two components 5A, 5B have the same shape, preferably symmetrical with respect to two symmetry planes (longitudinal and transversal) orthogonal to each other. For the sake of simplicity, only the first component 5A is shown in FIG. 15.

Each component 5A, 5B, comprises an inner surface 51A and an outer surface 51B opposite said inner surface 51A. Each comprises four openings A, B, C, D intended to form, following the connection of the two components 5A, 5B, four corresponding openings 51, 52, 53, 54 of the bipolar plate 5′. These, following the stacking of the elementary cells 20, contribute to defining the potash distribution channels and the reaction product collection channels. Each component 5A, 5B also comprises two other openings E, F which, following the connection of the two components 5A, 5B, define the delivery opening 55 and the return opening 56 intended for the formation of the delivery channel 4A and the return channel 4B of the cooling water.

Each component 5A, 5B comprises a plurality of grooves 65 which develop in the thickness of the plate itself starting from the corresponding inner surface 51A. Such grooves 65 are preferably made through mechanical processing, for example by means of milling. To define the bipolar plate 5′, the two components 5A, 5B are coupled so as to be specular with respect to a contact plane CP (indicated in FIG. 16). More precisely, the inner surface 51A of a component 5A is in contact with the inner surface 51A of the other component 5B. Furthermore, the grooves 65 of one component face corresponding grooves of the other component 5B so as to form pairs of mutually facing grooves, each of which defines an inner cavity 66 useful for the flow of the cooling fluid.

As visible from the sectional view of FIG. 16, preferably, the inner cavities 66 have a transversal section whose shape can be traced back to an ellipsoid, where such a transversal section is evaluated on a section plane orthogonal to said longitudinal development direction. However, in alternative embodiments, the transversal section could have a circular or still other shape.

With reference to the view of FIGS. 14, 15, it is observed that in this embodiment, for each element 5A of the bipolar plate 5′, the grooves 65 comprise a first curved section 65′, a second longitudinal section 65″ and a third section 65′″ preferably symmetrical to said first section 66′ with respect to a plane of transversal symmetry (X-X). As a result of such a shape, following the coupling of the two components 5A, 5B, the inner cavities 66 of water comprise a corresponding first section 66′ which develops between the inlet section SI (defined at the delivery opening 55) and through which the water reaches a second longitudinal section 66″. Through a third section 66′″, the water is conveyed towards the outlet section SV defined at the return opening 56 (see FIG. 14).

Passing through all the sections 66′, 66″, 66′″ of the inner cavities 66, in particular the second longitudinal section 66″, the cooling fluid removes heat from the two components 5A, 5B of the plate 5′ in accordance with the objects of the invention.

In the embodiment shown in FIGS. 14, 15 and 16 the outer surface 51B of each component 5A, 5B is advantageously flat. This solution allows to improve the thermal contact with the spacers 23A, 23B provided in the elementary cell. Further, the flatness of the outer surface 51B favours the arrangement of the sealing plate 26A, 26C provided between the bipolar plate 5 and the adjacent frame 22A, 22B. Overall, this solution improves the sealing of the elementary cells stack.

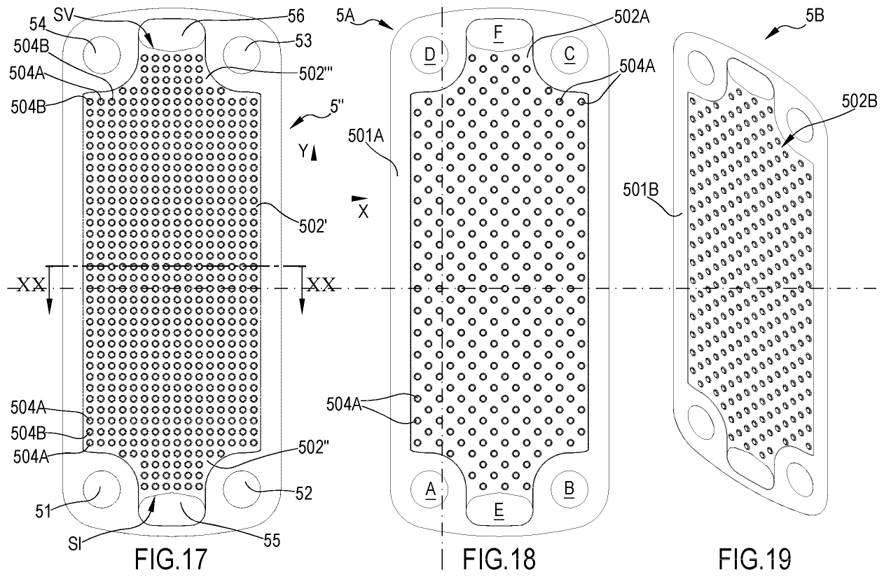

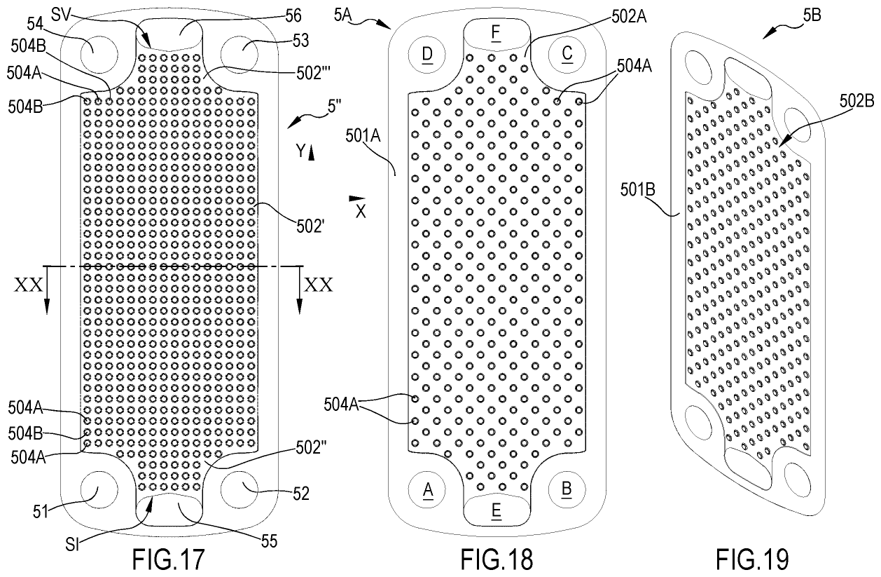

FIGS. 17 to 20 show a possible further embodiment of a bipolar plate for an electrolyzer according to the invention. To differentiate it from the previous embodiments described, the plate is indicated with the reference 5″ (in FIG. 17), while to indicate the two components constituting it, the references 5A and 5B are once again used.

FIGS. 18 and 19 are a front view and a perspective view, respectively, of the first component 5A and the second component 5B of the bipolar plate 5″. Similarly to what is envisaged for the bipolar plate 5 of FIG. 10, the components 5A and 5B of the bipolar plate 5″ are also made by molding and subsequently welded as better specified below.

The two components 5A, 5B of the plate 5″ have the same shape.

For each component 5A, 5B a flat part 501A, 501B and a molded part 502A, 502B are identified, surrounded by the flat part 501A, 501B. The flat part 501A, 501B defines four openings A, B, C, D (indicated only in FIG. 18) which, following the connection of the two components, go to form the four openings 51, 52, 53, 54 of the bipolar plate 5″ which in turn, following the stacking of the elementary cells 20, contribute to defining the potash distribution channels (11A, 12A) and the reaction product collection channels (11B, 12B).

Instead, for each component 5A, 5B the corresponding molded region 502A, 502B defines a first opening E and a second opening F which, following the union of the two components 5A, 5B, define the fifth opening 55 and the sixth opening 56 of the bipolar plate 5″ which, in turn, contribute to defining the delivery channel 4A and the return channel 4B for the cooling fluid circulating in the electrolyzer 1.

For each component 5A, 5B, the molded part 502A, 502B comprises a recessed portion 503A, 503B with respect to the plane PR on which said flat part 501A, 501B develops (see FIG. 20). The molded part 502A, 502B comprises a plurality of protrusions (bosses) 504A, 504B which develop from said recessed portion 503A, 503B beyond said reference plane PR. Said protrusions 504A, 504B are preferably arranged in rows according to two mutually orthogonal directions (longitudinal X and transversal Y) at pre-established intervals.

With reference to FIGS. 18 and 19, the two components 5A, 5B are connected at the respective flat parts 501A, 501B, i.e., on the contact plane which coincides with the reference plane PR indicated above. With respect to such a contact plane, the recessed portion 503A of the molded part 502A of the first component 50A remains arranged on a side opposite that in which the recessed portion 503B of the molded part 502B of the second component 5B is located (see in particular the section in FIG. 20). This arrangement gives rise to an inner cavity 66, comprised between the two recessed portions 503A, 503B useful for the flow of the water/cooling fluid.

With reference again to the sectional view of FIG. 20, it is observed that the protrusions 504A of the first component 5A contact the inner surface of the recessed portion 503B of the second component 5B, and vice versa the protrusions 504B of the second component 5B contact the inner surface of the recessed portion 503A of the first component 5A. Overall, the fluid can flow around the protrusions 504A, 504B inside the inner cavity 66, thereby cooling components 5A, 5B of the bipolar plate 5″. Advantageously, the contact between the protrusions 504A, 504B of a component 5A, 5B with the recessed portion 503A, 503B of the other component 5A, 5B contributes to the structural strength of the bipolar plate 5″.

It is observed that in the illustrated embodiment, the protrusions 504A, 504B have a substantially frusto-conical shape, where such a shape is evaluated on a plane parallel to said reference plane PR (again see FIG. 20). However, the possibility that such protrusions have a different configuration falls within the scope of the invention.

As indicated above, the two components 5A, 5B have the same configuration. It is observed that in FIG. 19, the second component 5B is illustrated with the respective molded part 502B in the foreground with respect to the relative flat part 501B. In other words, FIG. 19 shows the outer side of the second component 5B with respect to the inner cavity 66 in which the water/cooling fluid flows. Instead, FIG. 18 shows the inner side of the first component 5A, i.e., the one intended for contact with the second component 5B.

Starting from the condition illustrated in FIG. 19, to make the connection, the second component 5B is superimposed on the first component 5A so that the respective flat parts 501A, 501B come into contact and so that each protrusion 504A of one of the components 5A, 5B comes into contact with the inner surface of the recessed portion 503A, 503B of the other component. It is observed that at the end of the connection, each protrusion 504B of the second component 5B is surrounded by a protrusion 504A of the first component 5A and vice versa. In other words, along each of the orthogonal directions (X, Y) in which the protrusions 504A, 504B are distributed, the protrusions 504A of the first component 5A are interspersed with protrusions 504B of the second component 5B and vice versa (see FIG. 17).

With reference to FIG. 17, in the bipolar plate 5″, the inner cavity 66 formed by the coupling of the two molded areas 502A, 502B of the two components 5A, 5B, comprises a central area 502′ of substantially rectangular shape which develops along the two main directions (X, Y) and two bottleneck areas 502″, 502′″, opposite with respect to said central area 502′, which develop between the latter and the corresponding opening 55A, 56A defined above. The two bottleneck areas 502″, 502′″ respectively configure the inlet section SI and the outlet section SV of the cooling fluid of the bipolar plate 5″ respectively at the delivery opening 55 and the return opening 56.

Referring again to FIG. 17, during normal operation, through the inlet section SI the cooling fluid enters between the components 5A, 5B of the bipolar plate 5″ and is distributed first between the protrusions 504A, 504B of a first bottleneck area 502″ and then between those of the central area 502′. Subsequently, the fluid passes through the second bottleneck area 502″ to exit from the bipolar plate 5″ through the outlet section SV.

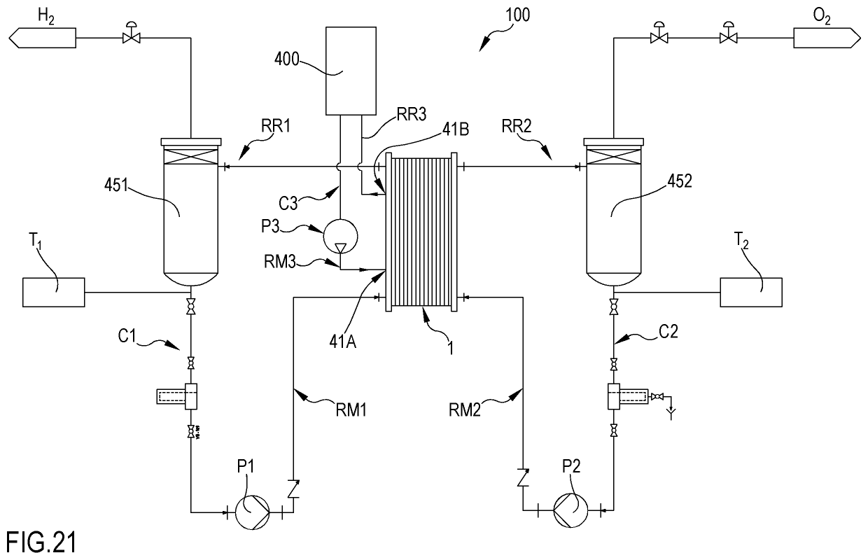

The present invention also relates to a plant 100 for the industrial production of hydrogen comprising an electrolyzer 1 according to the invention. FIG. 21 shows a diagram of a plant according to the invention which, in addition to the electrolyzer 1, comprises a first circuit C1 for the circulation of the electrolyte and a second circuit C2 for the circulation of the electrolyte. Each circuit C1, C2 comprises a delivery branch RM1, RM2 hydraulically connected to one of the distribution channels 11A, 12A through the relative inlet 111A, 112A. Each circuit C1, C2 further comprises a return branch RR1, RR2 connected to one of the collection channels 11B, 12B through the relative outlet 111B, 112B. Each circuit C1, C2 further comprises a degasser 451, 452 arranged between the relative delivery branch RM1, RM2 and the relative return branch RR1, RR2. For each circuit C1, C2 a circulation pump P1, P2 is also provided along the relative return branch RR1, RR2.

In accordance with the invention, the plant 100 comprises a further circuit C3 for the circulation of the cooling fluid. Such a further circuit C3 comprises a tank 400 and a delivery ramp RM3 hydraulically connected to the delivery channel 4A of the electrolyzer 1 through the relative inlet 41A. The circuit also envisages a return branch RR3 hydraulically connected to the return channel 4B of the electrolyzer 1 through the relative outlet 41B. A circulation pump P3 is arranged along the delivery branch RM3 which supplies the delivery channel 4A with the cooling fluid pumped from the tank 400. Through the return branch RR3 of the third circuit C3, the cooling fluid exiting the delivery channel 4B of the electrolyzer is returned to the tank 400 for subsequent recirculation.

Preferably, the circulation pump P3 of the third circuit C3 can be driven independently from the circulation pumps P1, P2 of the two circuits C1, C2 in which the electrolyte circulates. Thereby, the circulation of the cooling fluid can continue even when the electrolyzer is stopped, i.e., when the circulation of the electrolyte inside the electrolyzer itself is stopped. This condition allows effectively counteracting the possible damage deriving from the battery effect mentioned above.

From the comparison between the diagram of FIG. 21 and that of FIG. 1, related to a known type of plant, it can be deduced that the use of the electrolyzer according to the present invention allows eliminating the use of the two heat exchangers normally used to cool the electrolyte before its entry into the electrolyzer. It has also been seen that, with respect to the known plants such as that of FIG. 1, the possibility of reducing the operating flow rate of the electrolyte allows limiting the residence times in the degassers of the plant with evident advantages in terms of productivity.

The solutions described above allow the preset task and objects to be fully accomplished. In particular, the proposed device is particularly convenient and practical, effective and easily to make at low costs.

1-10. (canceled)

11. An electrolyzer for the production of hydrogen from an alkaline electrolyte, wherein the electrolyzer comprises:
a first header and a second header made of metallic material;
a plurality of elementary cells and a plurality of bipolar plates arranged between the headers, wherein the elementary cells are separated from each other by one of the bipolar plates;
clamping elements that mechanically connect the headers so that the elementary cells and the bipolar plates remain stably stacked between the headers;
wherein each of the elementary cell comprises:
an anodic portion including an anode electrode and an anodic frame defining a chamber in which the anode electrode is at least partially housed, the anodic portion including at least one sealing plate interposed between the anodic frame and one of the bipolar plates, the anodic portion further comprising an anodic spacer made of metallic material and interposed between the one of the bipolar plates and the anode electrode;
a cathodic portion including a cathode electrode and a cathodic frame defining a chamber in which the cathode electrode is at least partially housed, the cathodic portion including at least one sealing plate interposed between the cathodic frame and another of the bipolar plates, the cathodic portion further comprising a cathodic spacer made of metallic material and interposed between the cathode electrode and the another of the bipolar plates;
a separator element that separates the anodic portion from the cathodic portion;
at least a further sealing plate interposed between the anodic frame of the anodic portion and the cathodic frame of the cathodic portion;
the electrolyzer further comprising:
a first distribution channel of the alkaline electrolyte and a first collection channel of a first reaction product comprising mainly oxygen, wherein for each of the elementary cells, the channels are hydraulically connected to the chamber of the anodic portion via grooves defined by the anodic frame;
a second distribution channel of the alkaline electrolyte and a second collection channel of a second reaction product comprising mainly hydrogen, wherein, for each of the elementary cells, the second distribution channel and the second collection channel are hydraulically connected to the chamber of the cathodic portion via grooves defined by the cathodic frame;
wherein each of the bipolar plates comprises two plate-form components coupled together and configured to define one or more internal cavities for circulation of a cooling fluid, wherein, each bipolar plate comprises an inlet section and an outlet section respectively for the inlet and outlet of the cooling fluid into the one or more internal cavities;
the electrolyzer further comprising:
a delivery channel of the cooling fluid hydraulically connected to the inlet section of each of the bipolar plates; and
a return channel of the cooling fluid hydraulically connected to the outlet section of each of the bipolar plates.

12. The electrolyzer of claim 11, wherein the delivery channel comprises an inlet and the return channel comprises an outlet, wherein the inlet and the outlet are both positioned at one of the headers.

13. The electrolyzer of claim 12, wherein:
the first distribution channel and the second distribution channel of the electrolyte respectively comprise a first inlet and a second inlet positioned on one of the headers opposite to that on which the inlet of the delivery channel and the outlet of the return channel are positioned; and
the first collection channel and the second collection channel of the reaction products comprise a first outlet and a second outlet respectively that are positioned on the one of the headers.

14. The electrolyzer of claim 11, wherein, for each of the elementary cells, each frame comprises:
a first distribution aperture and a first collection aperture that are hydraulically connected to with the chamber defined by the relative frame via the grooves, wherein the first distribution aperture and the first collection aperture are defined in diagonally opposite positions;
a second distribution opening and a second collection opening that are not hydraulically connected to the chamber defined by the relative frame, wherein the second distribution opening and the second collection opening are defined in diagonally opposite positions;
a delivery and a return opening intended to be passed through, during the use of the electrolyzer, by the cooling fluid.

15. The electrolyzer of claim 14, wherein:
the sealing plates comprise six openings each configured and positioned in a compliant manner to a corresponding opening of each of the frames; and
each bipolar plate includes six apertures each configured and positioned in a compliant manner to one of the six apertures of each of the frames and to one of the six apertures of each of the seal plates.

16. The electrolyzer of claim 15, wherein following the stacking of the elementary cells between the headers:
one of the distribution apertures of each of the frames, a corresponding first aperture of each of the sealing plates and a corresponding first aperture of each of the bipolar plates define as a whole the first distribution channel of the electrolyte;
the other of the distribution apertures of each of the frames, a corresponding second aperture of each of the holding plates, and a corresponding second aperture of each of the bipolar plates define as a whole the second distribution channel of the electrolyte;
one of the collecting apertures of each of the frames, a corresponding third aperture of each of the sealing plates, and a corresponding third aperture of each of the bipolar plates define as a whole the first collecting channel of the electrolyte;
the other of the collecting apertures of each of the frames, a corresponding fourth aperture of each of the sealing plates, and a corresponding fourth aperture of each of the bipolar plates define as a whole the second collecting channel of the electrolyte;
the delivery opening of each of the frames, a corresponding fifth opening of each of the sealing plates and a corresponding fifth opening of each of the bipolar plates define as a whole the first delivery channel of the cooling fluid intended to pass internally through the bipolar plates; and
the return aperture of each of the frames, a corresponding sixth aperture of each of the seal plates and a corresponding sixth aperture of each of the bipolar plates define as a whole the return channel of the cooling fluid exiting the bipolar plates.

17. The electrolyzer of claim 11, wherein:
each component of the bipolar plate comprises a flat part and a molded part surrounded by the flat part, in which, for each of the components, the molded part is recessed with respect to a reference plane on which the flat part develops;
the components are connected at their respective flat parts so as to be symmetrical with respect to a contact plane coincident with the reference plane; and
the molded region of the first component is facing the molded region of the second component, the one or more internal cavities of the bipolar plate being defined between mutually facing molded regions of the components.

18. The electrolyzer of claim 17, wherein for each of the components the molded portion comprises at least one area with a substantially wavy shape defined by grooves alternating with ridges, and wherein as a result of the connection of the components, each of the ridges of the molded part of the first component contacts a corresponding ridge of the molded part of the second component, and wherein, as a result of the connection, the internal cavities for circulation of the cooling fluid are defined between two mutually facing grooves of the molded parts of the components.

19. The electrolyzer of claim 17, wherein:
for each of the components, the molded portion comprises a recessed portion with respect to the reference plane and a plurality of protrusions that develop from the recessed portion beyond the reference plane;
as a result of the connection of the components, the recessed portion of the molded portion of the first component remains arranged on a side opposite to that wherein the recessed portion of the molded portion of the second component is located, wherein between the recessed portions is defined the at least one inner cavity for the circulation of the cooling fluid; and
the protrusions of the first component contact the inner surface of the recessed portion of the second component and the protrusions of the second component contact the inner surface of the recessed portion of the first component.

20. The electrolyzer of claim 11, wherein:
the components comprise two flat metal plates, each of which comprises an inner surface and an outer surface opposite the inner surface;
each of the metal plates comprises a plurality of grooves that develop in the thickness of the plate from the corresponding inner surface;
the components are coupled so that the inner surface of one component results in contact with the inner surface of the other component; and
as a result of the contact, the grooves of one component face corresponding grooves of the other component, wherein a pair of mutually facing grooves defines an inner cavities for the circulation of the cooling fluid, the outer surface of the metal plates being flat.
